(19) United States
(12) Patent Application Publication
(10) Pub. No.: US 2019/0383090 A1
(43) Pub. Date: Dec. 19, 2019

(54) SMART PEEPHOLE

(71) Applicant: Goldtek Technology Co., Ltd., New Taipei City (TW)

(72) Inventors: LIH-SIN LEE, Taipei (TW); WEI-CHING KUO, Taichung (TW)

(21) Appl. No.: 16/411,399

(22) Filed: May 14, 2019

(30) Foreign Application Priority Data
Jun. 15, 2018 (TW) 107120886

(51) Int. Cl. E06B 7/30; E05F 15/00

(52) U.S. Cl. CPC E06B 7/30; E05F 15/00; E05Y 2900/132; E05Y 2400/61; E05Y 2201/11; E05Y 2400/654

(57) ABSTRACT

A smart peephole includes a front door body, a rear door body including a power source, and a connecting structure. The front door body includes a monitoring unit configured to monitor a scene. The connecting structure includes an electrical connection line, a connecting sleeve, and a regulator. The electrical connection line is configured to electrically couple the monitoring unit to the power source to provide power to the monitoring unit. The connecting sleeve passes through a door panel to couple the front door body to the rear door body. The regulator is disposed on the rear door body and is configured to adjust a length of the electrical connection line between the front door body and the rear door body according to a thickness of the door panel.

### FIELD

The subject matter herein generally relates to peepholes, and more particularly to a smart peephole for use in a door panel.

### BACKGROUND

Generally, a person inside a house can know a situation outside the house by looking through a peephole installed in an eyehole of the door panel. The peephole includes a lens. At present, the peephole provides a simple viewing function, which limits a monitoring performance. For example, a dead angle exists in a field of view through the peephole, communications between inside and outside of the house may not be sufficiently provided, hence, actual situations outside the house may not be transmitted to inside the house.

### BRIEF DESCRIPTION OF THE DRAWINGS

Implementations of the present disclosure will now be described, by way of embodiments, with reference to the attached figures.

FIG. 1 is an isometric view of an embodiment of a smart peephole.

FIG. 2 is an exploded, isometric view of a front door body of the smart peephole in FIG. 1.

FIG. 3 is an assembled, isometric view of the front door body in FIG. 2.

FIG. 4 is an isometric view of a rear door body of the smart peephole in FIG. 1.

FIG. 5 is a cross-sectional view of a regulator of the smart peephole.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising” means “including, but not necessarily limited to”; it specifically indicates open-ended inclusion or membership in a so-described combination, group, series and the like.

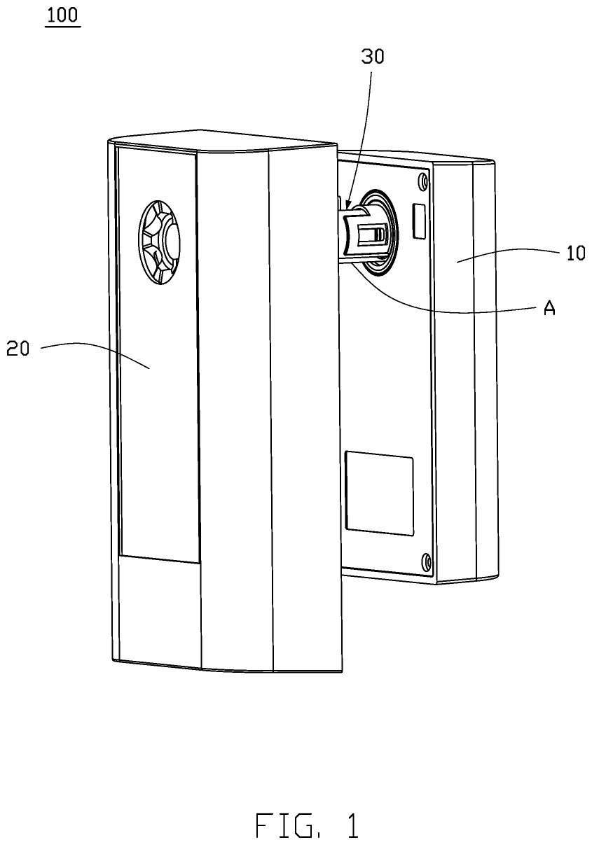

FIG. 1 shows an embodiment of a smart peephole 100. The smart peephole 100 is installed in a door (not shown) and includes a front door (or outer door) host 10, a rear door (or inner door) host 20, and a connecting structure 30. The front door body 10 and the rear door body 20 are respectively disposed on an outside and an inside of a house, and the connecting structure 30 is configured to couple the front door body 10 and the rear door body 20 through an eyehole (not shown) on a door panel. The connecting structure 30 includes an electrical connection line A disposed in the connecting structure 30, and the front door body 10 and the rear door body 20 are electrically coupled through the electrical connection line A. The eyehole on the door panel is a pre-fabricated hole on an existing door panel, which can be directly used for installing the smart peephole 100. Thus, a new door panel is not required to be installed, so that the smart peephole 100 is conveniently installed on the existing door panel.

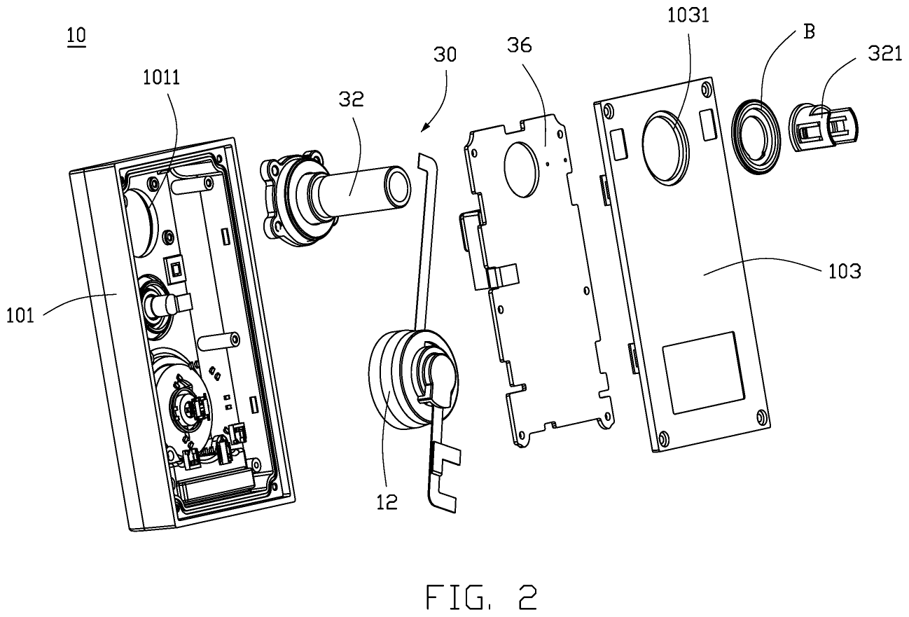

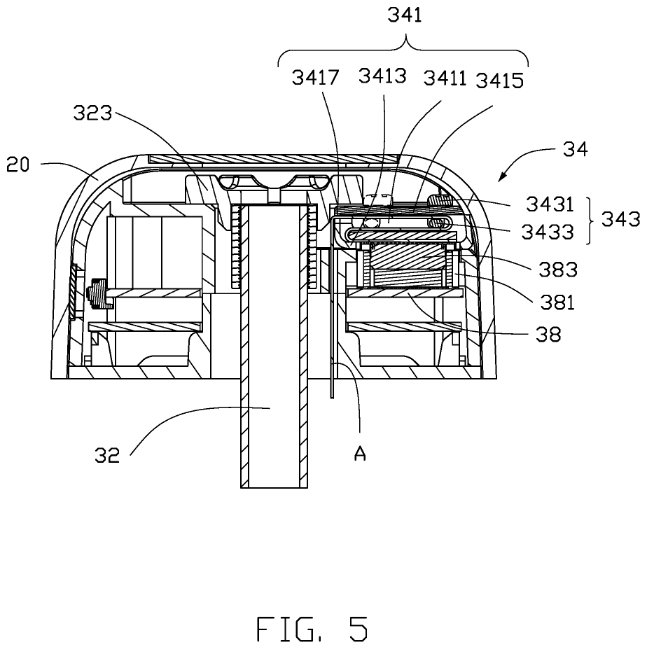

Referring to FIG. 2, a monitoring unit 12 is disposed in the front door body 10. A power source (not shown) is disposed in the rear door body 20 and is coupled to the electrical connection line A to provide power to the monitoring unit 12. The connecting structure 30 further includes a connecting sleeve 32 and a regulator 34 (shown in FIG. 5). The connecting sleeve 32 couples the front door body 10 to the rear door body 20 through the eyehole of the door panel. The regulator 34 is disposed on the rear door body 20 and is configured to adjust a length of the electrical connection line A between the front door body 10 and the rear door body 20, so that the front door body 10 and the rear door body 20 can be mounted on door panels of different thicknesses.

In one embodiment, the front door body 10 includes a front cover 101 and a rear cover 103. The front cover 101 defines a receiving space (not labeled). The monitoring unit 12 is received in the receiving space. The rear cover 103 is fixed to a rear of the front cover 101 to cover the receiving space. A front surface of the front cover 101 defines a first opening 1011, and the rear cover 103 defines a second opening 1031. The first opening 1011 is aligned with the second opening 1031, and the connecting sleeve 32 is received in the receiving space through the first opening 1011 and the second opening 1031, such that one end of the connecting sleeve 32 is aligned with the first opening 1011, and a second end of the connecting sleeve 32 protrudes through the second opening 1031. The rear cover 103 and the front cover 101 may be sealed together by a waterproof glue (not shown). An O-ring B is disposed in the second opening 1031 to fill in a space between the second opening 1031 and the connecting sleeve 32. The waterproof glue and the O-ring B effectively seal the receiving space enclosed by the front cover 101 and the rear cover 103, thereby sealing the monitoring unit 12 in the receiving space and achieving a dustproof and waterproof effect.

In one embodiment, the monitoring unit 12 includes a communication module (not shown) such as a pyro-electric infrared (PIR) detector, a camera lens, a speaker, and an antenna. The PIR detector is used for sensing a human body signal outside the house. The camera lens is used for capturing an image outside the house (including a person outside the house). The communication module sends the sensed human body signal and the captured image to a preset device, such as a smart phone, an indoor monitor, and the like, so that a user can monitor a situation outside the house. The speaker is used for voice communication between a person in the house and a person outside the house. The communication module may include, but is not limited to, a wireless communication module, such as WiFi, BLUETOOTH, LoRa, and the like.

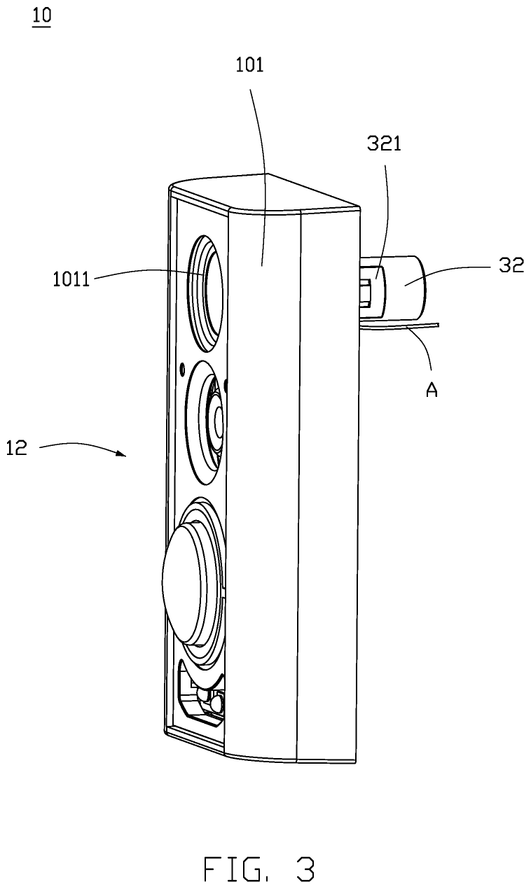

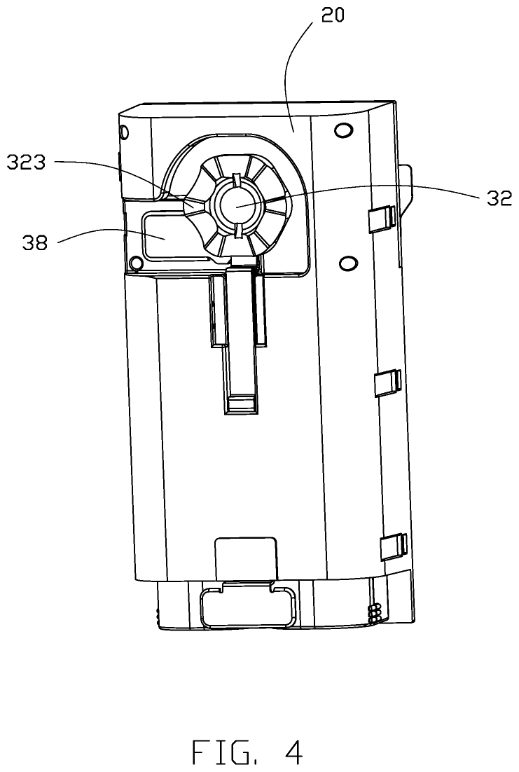

Referring to FIG. 3, the monitoring unit 12 installed in the receiving space faces the front surface of the front cover 101 to sense and detect the situation outside the door panel and can monitor the outdoor situation without any dead angle. Information monitored outside can be transmitted to the preset device inside, so that a person outside can communicate with a person inside through the monitoring unit 12. The monitoring unit 12 in the front door body 10 is powered by the rear door body 20. The connecting sleeve 32 includes a door ring 321 installed in the eyehole of the door panel. The door ring 321 fastens together the connecting sleeve 32 and the electrical connection line A, so that the power supplied from the rear door body 20 is transmitted to the front door body 10 through the electrical connection line A to the monitoring unit 12. In addition, the connecting sleeve 32 includes a fixing screw 323 (shown in FIG. 4) locked to the end of the connecting sleeve 32 passing through the rear door body 20. The fixing screw 323 is screwed on an outer edge of the connecting sleeve 32 to fix the connecting sleeve 32 to the rear door body 20.

The end of the connecting sleeve 32 facing outside the house may further include a lens (not shown) to allow a person inside the house to view a scene outside the house in a situation when the monitoring unit 12 does not operate for any reason (such as lack of a power supply). Because one end of the connecting sleeve 32 faces the first opening 1011 in the front door body 10 and the fixing screw 323 does not block the end of the connecting sleeve 32 in the rear door body 20, a scene outside can be directly monitored through the first opening 1011 from the end portion of the connecting sleeve 32 in the rear door body 20. Through combined use of the monitoring unit 12 and the lens, a scene outside the house can be easily monitored through the smart peephole 100 to ensure good home security.

In one embodiment, the connecting structure 30 further includes a first circuit board 36 (shown in FIG. 2) and a second circuit board 38 (shown in FIG. 4). The first circuit board 36 is disposed on the front door body 10, and the second circuit board 38 is disposed on the rear door body 20. The electrical connection line A is electrically coupled between the first circuit board 36 and the second circuit board 38. The first circuit board 36 is electrically coupled to the monitoring unit 12, and the second circuit board 38 is electrically coupled to the power supply of the rear door body 20, so that the power supplied from the rear door body 20 is transmitted through the electrical connection line A to the monitoring unit 12. In addition, the regulator 34 is disposed on the second circuit board 38 and is used to adjust a length of the electrical connection line A. Thus, the length of the electrical connection line A can be adjusted by the regulator 34 for door panels having different thicknesses to maintain electrical connection.

Referring to FIG. 5, the second circuit board 38 includes a socket 381 and a plug 383. The socket 381 is fixed to the second circuit board 38. The plug 383 is coupled to one end of the electrical connection line A, and the length of the electrical connection line A extending to the front door body 10 is adjusted by the regulator 34. In one embodiment, the regulator 34 includes a fastening seat 341 and a lever 343. The lever 343 is disposed on the fastening seat 341. The fastening seat 341 is fastened to the plug 383 and the electrical connection line A, and the length of the electrical connection line A extending to the front door body 10 is adjusted through the lever 343. Specifically, the fastening seat 341 defines a fastening slot 3411. The fastening slot 3411 includes an open end 3413 and a closed end 3415. The open end 3413 is opposite to the closed end 3415. The plug 383 is fastened in the open end 3413, and the lever 343 passes through the closed end 3415. The electrical connection line A is guided by the lever 343 to extend toward a guiding opening 3417 on a side of the fastening slot 3411 and extend out of the fastening slot 3411. In other words, the open end 3413 fastens the plug 383 so that a plug terminal of the plug 383 can protrude from the open end 3413, and then the plug 383 is plugged into the socket 381 on the second circuit board 38 to complete electrical connection therebetween. Furthermore, the lever 343 passed through the closed end 3415 is configured to slide in the closed end 3415 (as shown in FIG. 5, the lever 343 is shown slidable between a solid line position and a broken line position). In one embodiment, the lever 343 includes a toggle button 3431 and a rod body 3433. The toggle button 3431 and the rod body 3433 are coupled together and arranged opposite to each other. The toggle button 3431 is disposed on an outer surface of the closed end 3415 of the fastening slot 3411, and the rod body 3433 is located on an inner surface of the closed end 3415. The electrical connection line A is wrapped around the rod body 3433 and extends toward outside the fastening slot 3411 from the guiding opening 3417.

In use, when the electrical connection line A does not need to be extended, the toggle button 3431 is toggled to position the rod body 3433 in the solid line position in FIG. 5, so that the electrical connection line A accommodated in the fastening slot 3411, and a length of the electrical connection line A between the front door body 10 and the rear door body 20 is shortened. When the electrical connection line A is required to be extended, the toggle button 3431 is toggled to displace the rod body 3433 from the solid line position in FIG. 5 to the broken line position, so that the electrical connection line A wrapped around the rod body 3433 extends through the guiding opening 3417 toward the outside of the fastening slot 3411. Thus, by operating the lever 343, the length of the electrical connection line A extending toward the outside of the fastening slot 3411 can be adjusted for installation on door panels of different thicknesses.

The smart peephole 100 of the present disclosure can conveniently mount the front door body 10 and the rear door body 20 on the door panel through the connecting structure 30, and the monitoring unit 12 can effectively monitor the scene outside the door to enable communication between the inside and outside of the house and to transmit messages.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A smart peephole comprising:
a front door body;
a rear door body comprising a power source; and
a connecting structure; wherein:
the front door body comprises a monitoring unit configured to monitor a scene;
the connecting structure comprises an electrical connection line, a connecting sleeve, and a regulator;
the electrical connection line is configured to electrically couple the monitoring unit to the power source to provide power to the monitoring unit;
the connecting sleeve passes through a door panel to couple the front door body to the rear door body;
the regulator is disposed on the rear door body and is configured to adjust a length of the electrical connection line between the front door body and the rear door body according to a thickness of the door panel.

2. The smart peephole of claim 1, wherein:
the front door body comprises a front cover and a rear cover;
the front cover defines a receiving space for receiving the monitoring unit;
the rear cover is fixed to the front cover to cover the receiving space;
the front cover defines a first opening;
the rear cover defines a second opening;
the first opening is aligned with the second opening;
one end of the connecting sleeve is aligned with the first opening, and a second end of the connecting sleeve passes through the receiving space and protrudes through the second opening.

3. The smart peephole of claim 2, wherein:
the front cover is sealed to the rear cover by a waterproof glue;
an O-ring is disposed in the second opening to fill a space between the second opening and the connecting sleeve.
the receiving space is sealed by the waterproof glue and the O-ring.

4. The smart peephole of claim 1, wherein:
the connecting sleeve comprises a door ring disposed within an eyehole of the door panel;
the door ring fastens together the connecting sleeve and the electrical connection line.

5. The smart peephole of claim 4, wherein:
the connecting sleeve comprises a fixing screw for locking an end of the connecting sleeve passing through the rear door body;
the fixing screw is screwed on an outer edge of the connecting sleeve to fix the connecting sleeve to the rear door body.

6. The smart peephole of claim 1, wherein:
the connecting structure further comprises a first circuit board and a second circuit board;
the first circuit board is disposed on the front door body, and the second circuit board is disposed on the rear door body;
the electrical connection line is electrically coupled between the first circuit board and the second circuit board;
the regulator is disposed on the second circuit board.

7. The smart peephole of claim 6, wherein:
the second circuit board comprises a socket and a plug;
the socket is fixed to the second circuit board;
the plug is coupled to one end of the electrical connection line, and the length of the electrical connection line extending to the front door body is adjusted by the regulator.

8. The smart peephole of claim 7, wherein:
the regulator comprises a fastening seat and a lever;
the lever is disposed in the fastening seat;
the fastening seat is fastened to the plug and the electrical connection line;
extension of the electrical connection line is adjusted through the lever.

9. The smart peephole of claim 8, wherein:
the fastening seat defines a fastening slot;
the fastening slot includes an open end and a closed end;
the open end is opposite to the closed end;
the plug is fastened in the open end, and the lever passes through the closed end;
the electrical connection line is guided by the lever to extend toward a guiding opening on a side of the fastening slot and extend out of the fastening slot.

10. The smart peephole of claim 9, wherein:
the lever comprises toggle button and a rod body;
the toggle button and the rod body are coupled together and arranged opposite to each other;
the toggle button is disposed on an outer surface of the closed end, and the rod body is disposed on an inner surface of the closed end;
the electrical connection line is wrapped around the rod body and extends toward outside the fastening slot from the guiding opening.

11. A smart peephole comprising
a front door body;
a rear door body comprising a power source; and
a connecting structure; wherein:
the front door body comprises a monitoring unit configured to monitor a scene;
the connecting structure comprises an electrical connection line, a connecting sleeve, and a regulator;
the electrical connection line is configured to electrically couple the monitoring unit to the power source to provide power to the monitoring unit;
the connecting sleeve passes through a door panel to couple the front door body to the rear door body;
the regulator is disposed on the rear door body and is configured to adjust a length of the electrical connection line between the front door body and the rear door body according to a thickness of the door panel;
the monitoring unit is configured to transmit at least one of infrared and image information of the scene to a preset device.

12. The smart peephole of claim 11, wherein:
the front door body comprises a front cover and a rear cover;
the front cover defines a receiving space for receiving the monitoring unit;
the rear cover is fixed to the front cover to cover the receiving space;
the front cover defines a first opening;
the rear cover defines a second opening;
the first opening is aligned with the second opening;
one end of the connecting sleeve is aligned with the first opening, and a second end of the connecting sleeve passes through the receiving space and protrudes through the second opening.

13. The smart peephole of claim 12, wherein:
the front cover is sealed to the rear cover by a waterproof glue;
an O-ring is disposed in the second opening to fill a space between the second opening and the connecting sleeve,
the receiving space is sealed by the waterproof glue and the O-ring.

14. The smart peephole of claim 13, wherein:
the connecting sleeve comprises a door ring disposed within an eyehole of the door panel;
the door ring fastens together the connecting sleeve and the electrical connection line.

15. The smart peephole of claim 14, wherein:
the connecting sleeve comprises a fixing screw for locking the second end of the connecting sleeve passing through the rear door body;
the fixing screw is screwed on an outer edge of the connecting sleeve to fix the connecting sleeve to the rear door body.

16. The smart peephole of claim 11, wherein:
the connecting structure further comprises a first circuit board and a second circuit board;
the first circuit board is disposed on the front door body, and the second circuit board is disposed on the rear door body;
the electrical connection line is electrically coupled between the first circuit board and the second circuit board;
the regulator is disposed on the second circuit board.

17. The smart peephole of claim 16, wherein:
the second circuit board comprises a socket and a plug;
the socket is fixed to the second circuit board;
the plug is coupled to one end of the electrical connection line, and the length of the electrical connection line extending to the front door body is adjusted by the regulator.

18. The smart peephole of claim 17, wherein:
the regulator comprises a fastening seat and a lever;
the lever is disposed in the fastening seat;
the fastening seat is fastened to the plug and the electrical connection line;
extension of the electrical connection line is adjusted through the lever.

19. The smart peephole of claim 18, wherein:
the fastening seat defines a fastening slot;
the fastening slot includes an open end and a closed end;
the open end is opposite to the closed end;
the plug is fastened in the open end, and the lever passes through the closed end;
the electrical connection line is guided by the lever to extend toward a guiding opening on a side of the fastening slot and extend out of the fastening slot.

20. The smart peephole of claim 19, wherein:
the lever comprises toggle button and a rod body;
the toggle button and the rod body are coupled together and arranged opposite to each other;
the toggle button is disposed on an outer surface of the closed end, and the rod body is disposed on an inner surface of the closed end;
the electrical connection line is wrapped around the rod body and extends toward outside the fastening slot from the guiding opening;
the lever passed through the closed end is configured to slide in the closed end to adjust the length of the electrical connection line.
